(19) United States
(12) Patent Application Publication
(10) Pub. No.: US 2004/0109253 A1
(43) Pub. Date: Jun. 10, 2004

(54) Magnetic recording disk drive and method for ensuring magnetic recording function thereof

(75) Inventors: Nobumasa Nishiyama, Fujisawa-shi (JP); Mikio Suzuki, Fujisawa-shi (JP); Masaki Yoshinaga, Fujisawa-shi (JP); Yoichiro Kobayashi, Fujisawa-shi (JP); Hajime Aoi, Fujisawa-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi Global Storage Technologies Japan, Ltd.

(21) Appl. No.: 10/676,866

(22) Filed: Sep. 30, 2003

(30) Foreign Application Priority Data
Dec. 9, 2002 (JP) 2002-356466

(51) Int. Cl. G11B 5/09; G11B 27/36; G11B 5/02

(52) U.S. Cl. 360/46; 360/31; 360/55

(57) ABSTRACT

A magnetic recording disk drive having an interline crosstalk amplitude detection unit 36 within its preamplifier 20 is provided. The detection unit 36 is used for detection coil malfunctions. The interline crosstalk amplitude detection unit 36 includes an interline crosstalk amplitude detection circuit 31 which is branched from a branch circuit 30 within the read circuit in the preamplifier 20. The interline crosstalk amplitude detection unit 36 is provided with the capability to determine occurrence of a write condition abnormality when the amplitude has exceeded a threshold value, making it possible to ensure the recording function of the preamplifier 20. Likewise, the inductance is reduced when a circulatory shunt has occurred in a line near the head, making it possible to detect a write condition abnormality.

### CROSS REFERENCE TO RELATED APPLICATIONS

This application claims priority to Japanese Application No. 2002-356466, filed Dec. 9, 2002, the entire disclosure of which is incorporated by reference for all purposes.

### BACKGROUND OF THE INVENTION

The invention relates to a technique for read/write operation of a magnetic recording disk drive. More particularly, it relates to a method that is effective in ensuring magnetic recording function.

Techniques for increasing recording density and speeding up data transmission, i.e. increasing the read/write frequency, are essential to recording a large amount of data on a limited space and reading/writing a large amount data in a short time in a magnetic recording disk drive.

Further, in information recording, the data to be written is sent only once. Therefore the reliability of a recording function is very important. Accordingly, the preamplifier works to ensure the recording is done properly.

The items to be monitored for ensuring that the write data is not lost, are: (1) a breaking of wire in the magnetic field generator coil of the write head, (2) a circulatory shunt in the magnetic field generator coil of the write head, and (3) electric leakage from the wiring portion of the write head to the ground.

To detect a break in the coil (the above item (1)), the coil is checked to make sure that the write current is not lost. The circulatory shunt in the coil (the above item (2)), can be detected by monitoring the flyback voltage. This is possible because when circulatory shunt occurs, due to reduced inductance, the flyback voltage reduces. To detect electric leakage to the ground (the above item (3)), the changes in the currents other than the write current are monitored.

Another way of ensuring write operation, which is implemented in magnetic tape apparatuses, is to verify (check) whether the record data has been properly written by retrieving the data after the write operation. Still another way of ensuring magnetic write operation is to cause the write magnetic field to leak from the write head to the read head (MR head). Then, the waveform of the leakage magnetic field retrieved by the MR head is checked to see if the output write magnetic field matches the data pattern (as disclosed in U.S. Pat. No. 6,266,202).

Further, in still another way of ensuring write operation, the write head and the read head is disposed close to each other along the feed direction of the magnetic recording medium (for example a prepaid card) such that the influence of the crosstalk can be eliminated even when the write operation and the read operation is carried out at the same time. (as disclosed in Japanese published application JPA 6-349012). Also, one of the other ways is to increase the write and read frequency. This is achieved by removing a portion of the metal suspension under the connection pad connected to the signal line for transmitting signals from the magnetic head (as disclosed in Japanese published application JPA 2002-251706).

The following issues were raised, while investigating the above identified prior art.

Conventionally, magnetic recording disk drives like those described above have been configured such that the inductance of the write head is reduced to increase the write frequency. As a result, the inductance of the line has become equal to that of the write head, increasing the possibility that the detection circuit for ensuring write operation malfunctions.

For example, there is a method for checking the magnitude of the flyback voltage waveform to detect a circulatory shunt in the coil of the write head. This method, however, has a drawback. Assume that a circulatory shunt has occurred in the head coil, reducing its inductance since the write magnetic field is no longer produced. Even in such a case, since the flyback voltage waveform produced by the inductance of the transmission line is still large, there is a possibility that the write operation ensuring circuit mistakes the amplitude of the flyback voltage waveform produced by the inductance of the transmission line for that of a normal flyback voltage waveform. That is, by implementing the above method, there is a risk of judging an improper write operation as a proper one.

Also, as for the method of monitoring the write magnetic field using the read head, since the MR head has been improved so as to sense even a weak magnetic field, the head might be damaged if a strong magnetic field like the write magnetic field is input. Therefore, a shield, etc. is disposed to prevent the write magnetic field from leaking in as well as efficiently reading the recorded magnetic field from the medium. Therefore, it is difficult to ensure the write operation by using this method. Accordingly, what is needed is a method that ensures the recording to a magnetic recording disk drive.

### SUMMARY OF THE INVENTION

The embodiments of the present invention are directed to provide a magnetic recording disk drive that ensures the magnetic recording, by detecting the circulatory shunt, by way of monitoring interline crosstalk. This method is based on the fact that a circulatory shunt leads to a decreased inductance of the write line, which in turn leads to an increase of the interline crosstalk amplitude.

According to one embodiment of the present invention, the transmission line between the preamplifier and the read/write heads is arranged such that the write line and the read line run alongside of each other, producing a magnetic coupling (interline crosstalk). The transmission line is configured such that under ordinary use conditions, the crosstalk is reduced so as to protect the MR element. By implementing such configuration, the magnitude of the crosstalk from the write line to the read line due to the magnetic coupling is detected, to determine whether the magnetic recording function (write) is in a normal state or an abnormal state.

### BRIEF DESCRIPTION OF THE DRAWINGS

FIG. 1 is a diagram showing the configuration of a magnetic recording disk drive according to an embodiment of the present invention.

FIG. 2 shows the transmission line on an arm suspension in the magnetic recording disk drive according to the embodiment of the present invention, wherein FIG. 2(a) is a plane view of the transmission line while FIG. 2(b) is a cross-sectional view of the transmission line of FIG. 2(a) taken along line A-A′.

FIG. 3 shows the principle of occurrence of interline crosstalk in the parallel close arrangement section of the transmission line in the magnetic recording disk drive according to the embodiment of the present invention, wherein FIG. 3(a) is an explanatory diagram illustrating the principle of the occurrence of the interline crosstalk while FIG. 3(b) is an explanatory diagram illustrating electromagnetic induction produced by each magnetic line of force.

FIG. 4 is a cross-sectional view of a transmission line that was used to determine whether the write head coil was in a normal state or an abnormal state in the magnetic recording disk drive according to the embodiment of the present invention.

FIG. 5 is an explanatory diagram showing a comparison of crosstalk amplitude voltages of a normal write head sample and an abnormal write head sample in determination of occurrence of an abnormality in the write head coil in the magnetic recording disk drive according to the embodiment of the present invention.

FIG. 6 is a graph showing the changes in the crosstalk amplitude voltages of the normal write head sample and the abnormal write head sample with frequency in determination of occurrence of an abnormality in the write head coil in the magnetic recording disk drive according to the embodiment of the present invention.

FIG. 7 is an explanatory diagram showing amplitude ratios obtained as a result of evaluating the graph of FIG. 6 in determination of occurrence of an abnormality in the write head coil in the magnetic recording disk drive according to the embodiment of the present invention.

FIG. 8 is a graph showing the change in the crosstalk amplitude voltage of the abnormal write head sample with time in determination of occurrence of an abnormality in the write head coil in the magnetic recording disk drive according to the embodiment of the present invention.

FIG. 9 is a graph showing the change in the crosstalk amplitude voltage of the normal write head sample with time in determination of occurrence of an abnormality in the write head coil in the magnetic recording disk drive according to the embodiment of the present invention.

FIG. 10 is a graph showing the changes in the inductances with time in determination of occurrence of an abnormality in the write head coil in the magnetic recording disk drive according to the embodiment of the present invention.

FIG. 11 is a diagram showing the configuration of the interline crosstalk amplitude detecting unit within the preamplifier in the magnetic recording disk drive according to the embodiment of the present invention.

The following table includes a description of reference numerals.

| | |
|---|---|
| 10 | HDA |
| 13 | magnetic recording medium |
| 14 | magnetic head |
| 14W | write head coil terminal |
| 14R | read head output terminal |
| 15 | carriage unit |
| 16 | FPC |
| 18 | arm |
| 19 | suspension |
| 20 | ream lifier |
| 20W | write amplifier |
| 20R | read am lifier |
| 21 | transmission line |
| 21W | write line |
| 21R | read line |
| 21a | parallel close arrangement section |
| 21b | separation section |
| 30 | branch circuit |
| 31 | detection circuit |
| 32 | comparator |
| 33 | serial data controller |
| 34 | signal source |
| 35 | write condition abnormality signal |
| 36 | interline crosstalk amplitude detecting unit |
| 40 | write conductors |
| 41 | read conductors |
| 42 | cover |
| 43 | base |
| 44 | lower conductor |
| 50 to 52 | magnetic line of force |
| 60 | read-to-write line distance |
| 61 | write line width |

### DESCRIPTION OF ILLUSTRATIVE EMBODIMENTS

The change in the amplitude of the crosstalk is detected, as follows. Let La denote the inductance of the write head in a normal state. Further, let Lb denote the inductance of the write head when a circulatory shunt has occurred in its coil. Then, Lb is smaller than La. On the other hand, since the characteristic impedance of the transmission line is not equal to the impedance of the write head, a current reflection appears. The transient response characteristics of the reflection current are such that a smaller inductance Lb produces a more steeply rising reflection current. Accordingly, when a circulatory shunt has occurred in the coil of the write head and thereby its inductance has been reduced, the rising edge of the waveform of the write current including the reflection current becomes steeper, producing larger interline crosstalk.

Similarly, when a circulatory shunt has occurred in the line to the write head, both the impedance and the inductance of the circulatory shunted portion are reduced and thereby the transient response of the reflection current becomes faster, also increasing the interline crosstalk. According to the present invention, a crosstalk amplitude detecting means is provided within the read circuit preamplifier to detect the change in the amplitude of the interline crosstalk described above. With this arrangement, the present invention compares the detected amplitude with the amplitude of crosstalk in a normal system. If the detected amplitude is larger, the present invention judges that a circulatory shunt has occurred in the writing system and performs processing accordingly.

Specifically, a magnetic recording disk drive of the present invention comprises: a spindle unit constructed of laminated magnetic recording media; a voice coil motor; an arm; a suspension mounted on the tip of the arm; a magnetic head mounted on the tip of the suspension for reading/writing information on a magnetic recording medium; a flexible patterned cable (FPC) for transmitting read/write signals; a preamplifier mounted on the FPC and having a write abnormality detecting function; and a carriage unit having mounted thereon a transmission line for transmitting read/write signals between the preamplifier and the magnetic head. The present invention is applied to the head/disk assembly of a magnetic recording disk drive enclosed entirely by aluminum plates, and has the following features.

(1) According to one aspect of the present invention, the above magnetic recording disk drive is further characterized in that the transmission line from the preamplifier to the magnetic head includes a section in which a write line and a read line run alongside of each other to produce interline crosstalk, the transmission line being formed such that it is branched within a read preamplifier, wherein the magnetic recording disk drive further comprises: a detection circuit for receiving a signal from a line branched off within the read preamplifier to detect an interline crosstalk amplitude value; a signal source for outputting a threshold value (indicating a dividing line) used to determine whether an interline crosstalk amplitude in the detection circuit is one obtained under normal conditions or abnormal conditions; a comparator for receiving and comparing an actual interline crosstalk amplitude value and a threshold value, and when the actual interline crosstalk amplitude value is larger than the threshold value, outputting a signal indicating a write condition abnormality, the actual interline crosstalk amplitude value being an output of the detection circuit, the threshold value being an output of the signal source; and wherein the magnetic recording disk drive has a function to determine occurrence of the write condition abnormality upon receiving the signal indicating the write condition abnormality, the signal being output from the comparator.

(2) According to another aspect of the present invention, the above magnetic recording disk drive in (1) is further characterized in that the transmission line from the preamplifier to the magnetic head is set such that a distance between a center of the write line and a center of the read line in the section in which the write line and the read line run alongside of each other is 5 or less (3 to 5.5) times a width of the write line.

(3) According to still another aspect of the present invention, the above magnetic recording disk drive in (1) is further characterized in that the transmission line from the preamplifier to the magnetic head is configured such that the section in which the write line and the read line run alongside of each other is constructed of one layer or two layers made up of an upper layer and a lower layer, the upper layer being a line, the lower layer being a transmission line made up of a common potential conductor layer.

(4) According to yet another aspect of the present invention, there is provided a method for ensuring magnetic recording function of a magnetic recording disk drive as described earlier, the magnetic recording disk drive further comprising: a detection circuit for detecting an actual interline crosstalk amplitude value; a signal source for outputting a predetermined threshold value; an external interface for controlling the threshold value output from the signal source; and a comparator for receiving and comparing an output of the detection circuit and an output of the signal source; wherein the method comprises the step of: to check an interline crosstalk amplitude under normal conditions, changing the threshold value output from the signal source by use of the external interface, obtaining a threshold value at which an output of the comparator is inverted, and checking whether the obtained threshold value is an interline crosstalk amplitude value under normal conditions.

(5) According to still a further aspect of the present invention, the method for ensuring magnetic recording function of a magnetic recording disk drive described in (4) is further characterized in that the threshold value output from the signal source is set within a range from the interline crosstalk amplitude value under normal conditions to an interline crosstalk amplitude value under abnormal conditions.

(6) According to yet another aspect of the present invention, there is provided a magnetic recording disk drive which is configured as described earlier and further characterized in that the magnetic recording disk drive has a function to: when an inductance of a load connected to a write line is 50% or less (43% to 69%) of an inductance of a normal load, produce an interline crosstalk 1.5 or more (1.35 to 2) times as large as an interline crosstalk under the normal load, both interline crosstalks being produced from the write line to a read line in the transmission line from the preamplifier to the magnetic head, an amplitude of the interline crosstalk under the normal load being used as a reference; detect and recognize a difference between amplitudes of both interline crosstalks; and output a signal indicating a write condition abnormality.

One embodiment of the present invention will be described in detail below with reference to the accompanying drawings.

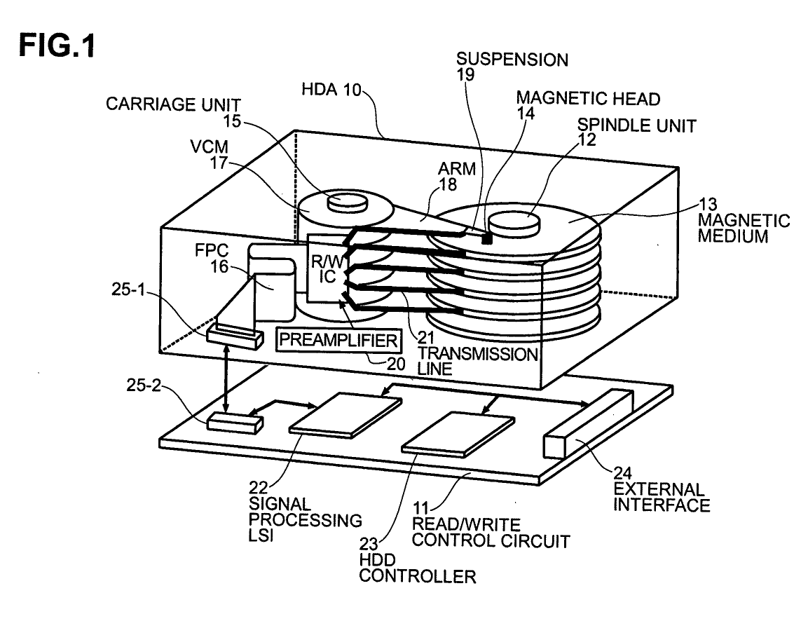

Description will be made of a configuration of a magnetic recording disk drive according to an embodiment of the present invention with reference to FIG. 1. FIG. 1 is a diagram showing a configuration of the magnetic recording disk drive.

The magnetic recording disk drive of the present embodiment is made up of, for example, an HDA (head disk assembly) 10, a read/write control circuit 11, etc.

The HDA 10 is made up of: a spindle unit 12 constructed of laminated magnetic recording media 13; and a carriage unit 15 which has mounted thereon a magnetic head 14 for reading/writing information on the magnetic recording media 13, etc.

The carriage unit 15 comprises: a VCM (voice coil motor) 17 for positioning a magnetic head 14 on the magnetic recording media 13 in a seek operation; an arm 18; a suspension 19 mounted on the tip of the arm 18; the magnetic head 14 mounted on the tip of the suspension 19; an FPC (flexible patterned cable) 16 for transmitting read/write signals; a preamplifier 20 mounted on the FPC 16; and a transmission line 21 for transmitting read/write signals between the preamplifier 20 and the magnetic head 14.

The read/write control circuit 11 is provided between the HDA 10 and the external equipment. The read/write control circuit 11 has mounted thereon a signal processing LSI 22 and an HDD (hard disk drive) controller 23. The preamplifier 20 and the signal processing LSI 22 are connected together by connecting a connector 25-1 on the “HDA 10” side with a connector 25-2 on the “read/write control circuit 11” side. The external interface 24 of the read/write control circuit 11 provides a connection with external equipment.

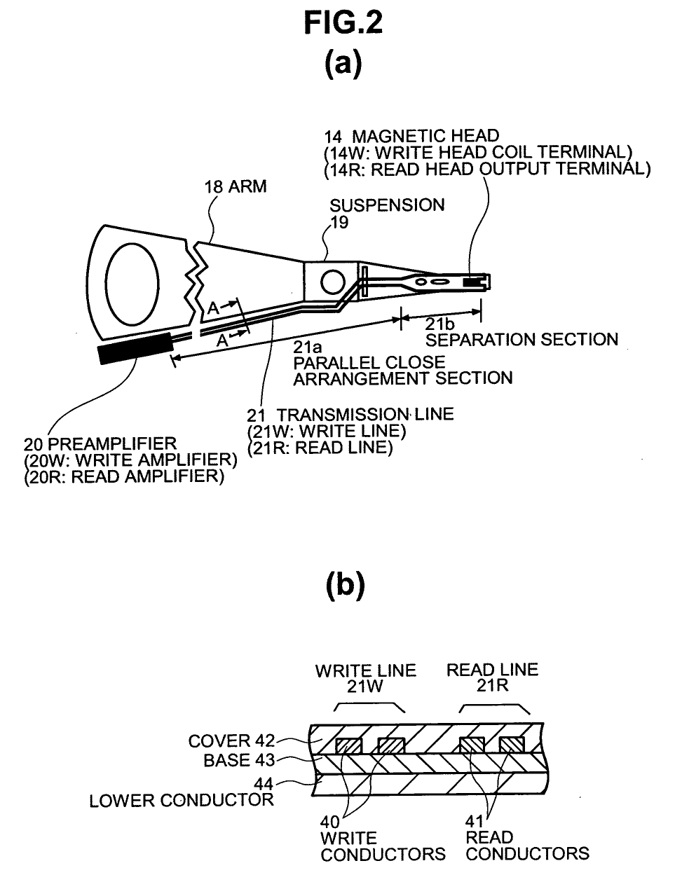

Description will be made below of an example of the transmission line on the arm suspension of the magnetic recording disk drive of the present embodiment with reference to FIG. 2. FIG. 2 shows the transmission line on the arm suspension and includes FIGS. 2(a) and 2(b). FIG. 2(a) is a plane view of the transmission line, while FIG. 2(b) is a cross-sectional view of the transmission line of FIG. 2(a) taken along line A-A′.

As shown in FIG. 2(a), the transmission line 21 runs from the preamplifier 20 to the magnetic head 14 along one side of the arm 18 and is printed on the suspension 19. The magnetic head 14 provided with a write head coil terminal 14W, a read head output terminal 14R, etc. is connected to one end of the transmission line 21. The preamplifier 20 made up of a write amplifier 20W and a read amplifier 20R is connected to the other end of the transmission line 21.

The transmission line 21 is made up of a write line 21W and a read line 21R and divided into two sections: a parallel close arrangement section 21a in which the write line 21W and the read line 21 run alongside of each other; and a separation section 21b in which they are disposed away from each other. It is in the parallel close arrangement section 21a that the interline crosstalk occurs. FIG. 2(b) shows the physical relationship between the write line 21W and the read line 21R in the parallel close arrangement section 21a. That is, the write line 21W and the read line 21R are disposed with a predetermined space therebetween. The write line 21W is made up of a pair of write conductors 40, while the read line 21R is made up of a pair of read conductors 41. The write conductors 40 and the read conductors 41 are disposed on a base 43 laminated on the top surface of a lower conductor 44, and covered with a cover 42.

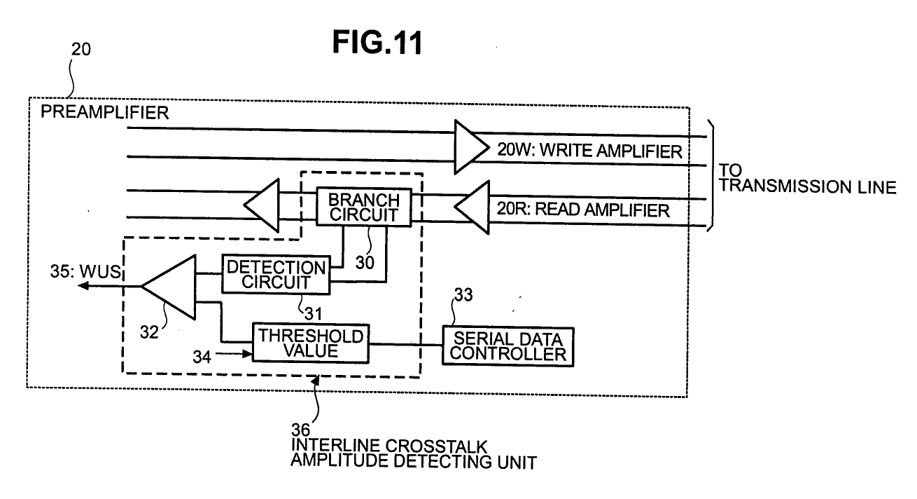

Thus, in the magnetic recording disk drive configured as described above, the preamplifier 20 and the read/write magnetic head 14 are connected by way of the read/write transmission line 21, which is configured such that the write line 21W and the read line 21R run alongside of each other partially or entirely. Furthermore, the read signal within the preamplifier is branched, and the magnetic recording disk drive has a portion (an interline crosstalk amplitude detecting unit 36 shown in FIG. 11 described later) having a function to check the amplitude of the crosstalk induced on the read line 21R. The transmission line 21 may be constructed of two layers; the upper layer may be made up of line conductors and the lower layer may be made up of a bottom conductor providing a common potential. Or alternatively, the transmission line 21 may consist of a single-layer structure made up of line conductors.

Description will be made below of write operation on information in the magnetic recording disk drive. Generally, information is written as follows.

First of all, information supplied from the host apparatus is converted to patterned data suitable for magnetic write/read operation. Then, a write current is produced such that each “1” of the patterned data corresponds to inversion of the write current while each “0” of the data corresponds to non-inversion. The write current whose polarity is thus changed according to the patterned data is output from the write amplifier 20W of the preamplifier 20 to the write line 21W. This write current is fed to the write head coil terminal 14W of the magnetic head 14 by way of the write line 21W.

The write current is then fed from the write head coil terminal 14W to the write magnetic field generator coil inside the magnetic head 14, thereby producing a write magnetic field whose direction corresponds to the polarity of the current. Current reversal, i.e. magnetization reversal, is recorded on the magnetic recording media 13 for each “1” of the patterned data, while no current reversal, i.e. no magnetization reversal, is recorded for each

When the written information is read, on the other hand, the read head (MR head) of the magnetic head 14 senses each magnetization direction in the magnetic recording media 13 and converts it into a voltage change which is then input to the preamplifier 20. The preamplifier 20 amplifies the read signal by use of the read amplifier 20R and sends it to the LSI which then decodes the data pattern to retrieve the written information.

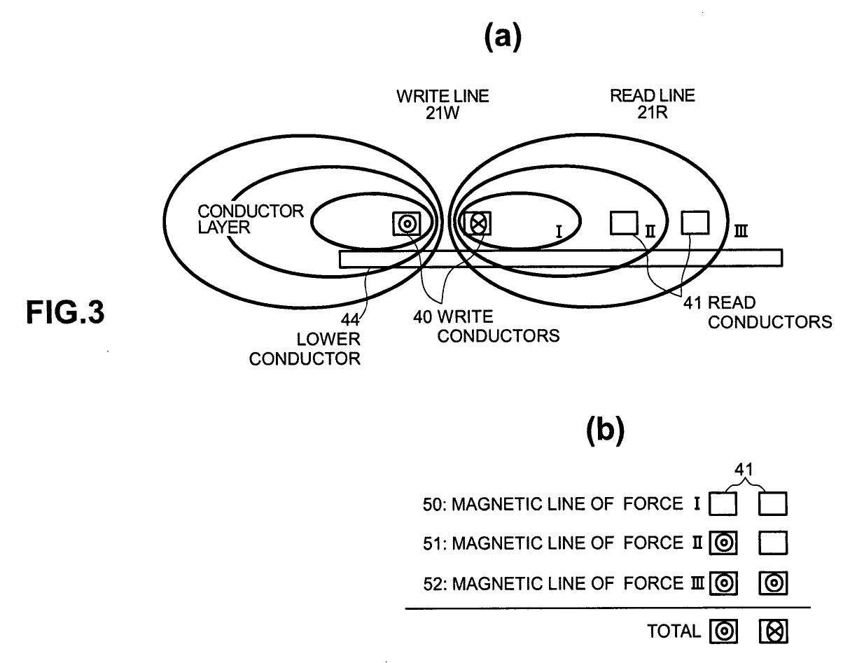

Description will be made below of the principle of occurrence of interline crosstalk in the parallel close arrangement section of the transmission line with reference to FIG. 3. FIG. 3 shows the principle of the occurrence of the interline crosstalk and includes FIGS. 3(a) and 3(b). FIG. 3(a) is an explanatory diagram illustrating the principle of the occurrence of the interline crosstalk, while FIG. 3(b) is an explanatory diagram illustrating electromagnetic induction produced by each magnetic line of force.

As shown in FIG. 3(a), a write current is differentially supplied to the write line 21W in the parallel close arrangement section 21a of the transmission line 21. At that time, a magnetic field corresponding to the current is produced around the write conductors 40. This magnetic field is characterized in that it becomes weaker as its distance from the write conductors 40 increases. Therefore, of the representative magnetic lines of force 50(I), 51(II), and 52(III), the magnetic line of force 50 produces the strongest magnetic field.

The magnetic field intensity produced by the magnetic line of force 51 is the second highest. However, since the magnetic line of force 51 forms a linkage with one conductor of the read line 21R (passes through the space between the two conductors), electromagnetic induction (interline crosstalk) is produced on the conductor, as shown in FIG. 3(b).

Further, the magnetic line of force 52, whose magnetic field intensity is the lowest, produces electromagnetic induction on both read conductors 41. The electromagnetic induction on one read conductor 41 and that on the other have the same polarity and therefore the differential induction current flowing through the read line 21R has little influence (the magnitude of the differential induction current is minimal).

Therefore, it is the magnetic line of force 51 that produces (major) interline crosstalk. The present invention effectively uses the magnitude of the interline crosstalk produced by the magnetic line of force 51 to determine whether the recording function is in a normal state or an abnormal state.

Thus, when a write current is passed through the write line 21W, interline crosstalk whose magnitude corresponds to the state of the write load appears on the read line 21R. Accordingly, the amplitude of the crosstalk can be detected to determine the state of the write head.

Description will be made below of the relationship between the write line load and the interline crosstalk amplitude. In the parallel close arrangement section 21a of the write line 21W and the read line 21R of the transmission line 21 in which interline crosstalk occurs, the amplitude of the crosstalk waveform increases as the time rate of change of the write current increases.

A reflection current always flows through the write line 21W to the input of the write head coil due to the impedance mismatch. This reflection current is determined by both the characteristic impedance of the transmission line 21 and the impedance of the write head and exhibits a transient response. The time constant of the transient response is such that τ=Lh/(Zo+Rh), where Lh is the inductance of the write head, Rh is the resistance of the write head, and Zo is the characteristic impedance of the transmission line.

That is, when the inductance of the write head is reduced due to a circulatory shunt in the coil, etc., the time constant τ becomes smaller, increasing the time rate of change of the write current. Since the amplitude of the interline crosstalk waveform is proportional to the time rate of change of the write current, the amplitude of the interline crosstalk waveform is expected to increase.

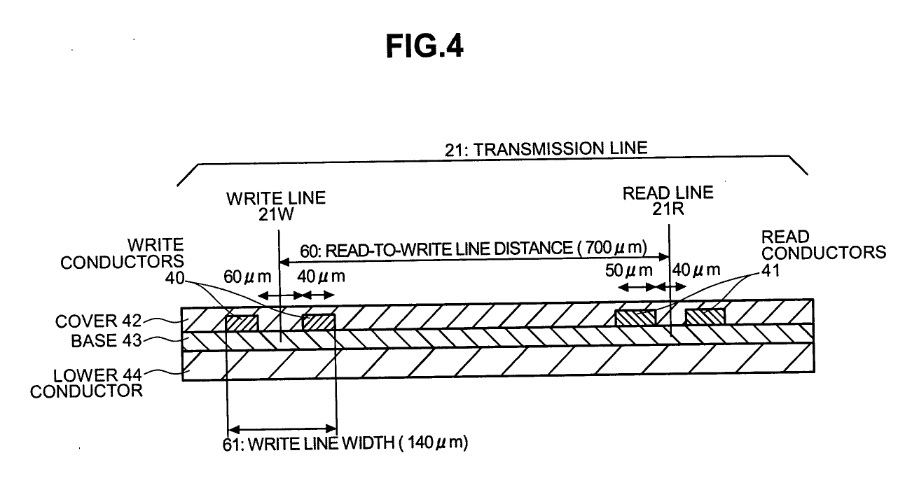

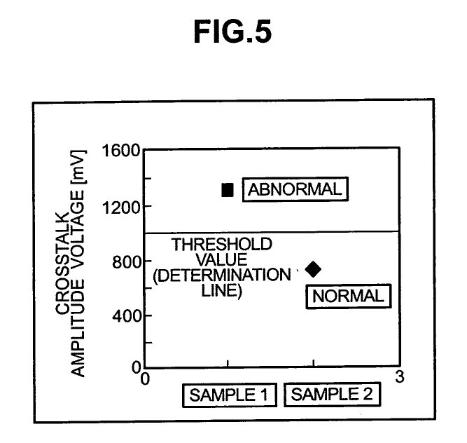

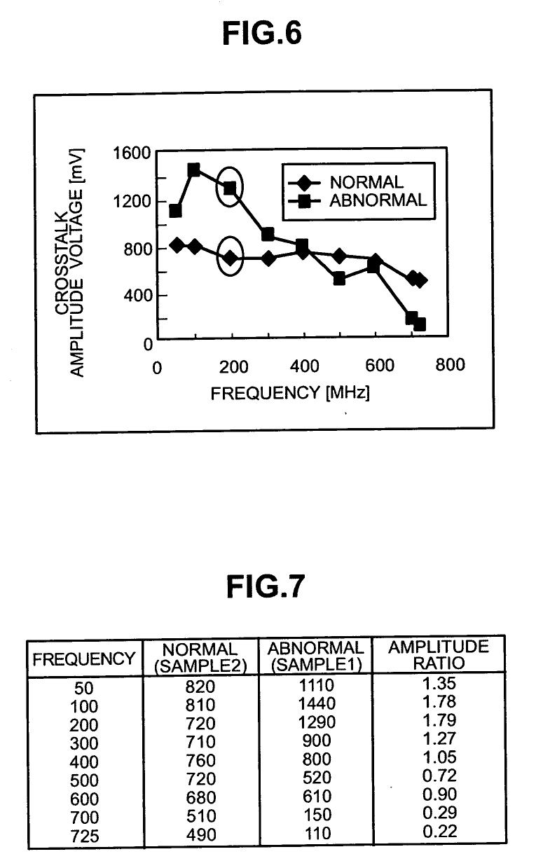

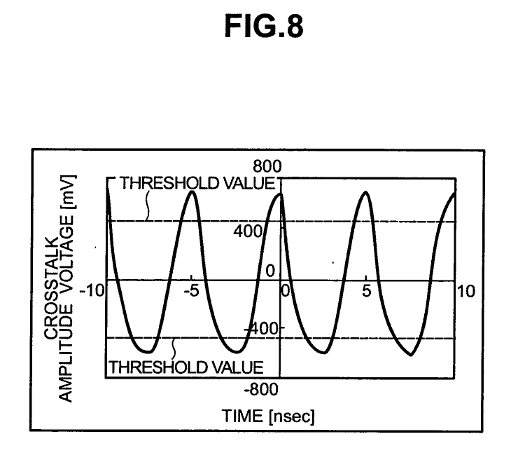

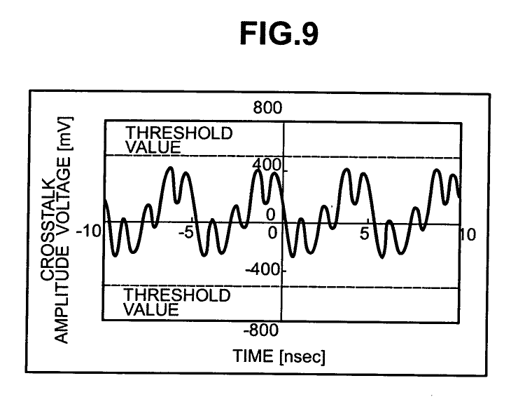

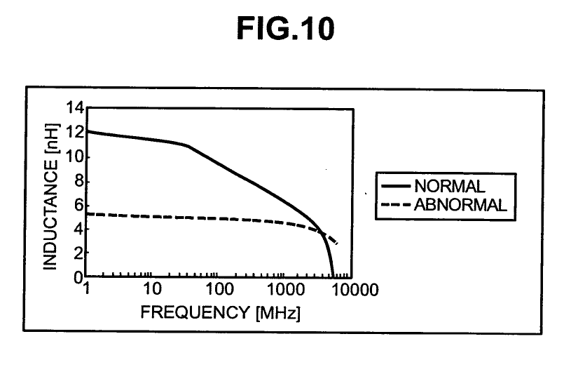

With reference to FIGS. 4 to 10, description will be made below of an evaluation result obtained by comparing the amplitudes of interline crosstalk waveforms produced by samples of normal and abnormal write heads. FIG. 4 is a cross-sectional view of a transmission line that was used to determine whether the write head coil was in a normal state or an abnormal state; FIG. 5 is an explanatory diagram showing a comparison of crosstalk amplitude voltages of the normal and the abnormal write head samples; FIG. 6 is a graph showing the changes of the crosstalk amplitude voltages of the normal and the abnormal write head samples with frequency; FIG. 7 is an explanatory diagram showing amplitude ratios obtained as a result of evaluating the graph of FIG. 6; FIG. 8 is a graph showing the change of the crosstalk amplitude voltage of the abnormal write head sample with time; FIG. 9 is a graph showing the change of the crosstalk amplitude voltage of the normal write head sample with time; and FIG. 10 is a graph showing the changes in the inductances with frequency.

As shown in FIG. 4, the transmission line 21 that was used to determine whether the write head was in a normal state or an abnormal state was configured as follows. The read-to-write line distance 60 between the center of the write line 21W and the center of the read line 21R is 700 μm; the write line width 61 of the write line 21W is 140 μm; the width of each write conductor 40 is 40 μm; the distance between the write conductors is 60 μm; the width of each read conductor 41 is 50 μm; and the distance between the read conductors is 40 μm. Thus, the read-to-read line distance 60 is set to be (approximately) five times the write line width 61.

As shown in FIG. 5, in this evaluation of write heads in which whether they are in a normal state or an abnormal state is determined, sample 2 is supposed to be a normal write head while sample 1 is supposed to be an abnormal write head. In this case, the boundary (determination line threshold) between the normal write head group and the abnormal write head group is at a crosstalk amplitude voltage of approximately 1200 mV.

As shown in FIGS. 6 and 7, when the frequency is varied approximately from 50 MHz to 725 MHz, the normal write head sample 2 exhibits only a small change in the crosstalk amplitude voltage, approximately from 820 mV to 490 mV. The abnormal write head sample 1, on the other hand, exhibits a large change, approximately from 1110 mV to 110 mV. For example, the ratio of the crosstalk amplitude voltage of the abnormal write head sample 1 to that of the normal write head sample 2 is 1.35 at a frequency of 50 MHz, 1.78 at 100 MHz, 1.79 at 200 MHz, . . . , 1.05 at 400 MHz, and 1 or less at 500 MHz or higher.

FIG. 8 shows the change in the crosstalk amplitude voltage of the abnormal write head sample 1 with time at a frequency of approximately 200 MHz, indicating a waveform in which the crosstalk amplitude voltage exhibits large changes on both the plus and minus sides. FIG. 9, on the other hand, shows the crosstalk amplitude voltage of the normal write head sample 2, indicating that the crosstalk amplitude voltage exhibits only small changes on both the plus and the minus sides. Each figure indicates threshold levels used to determine whether the sample is a normal write head sample or an abnormal write head sample.

As shown in FIG. 10, the inductance of the normal write head sample decreases with increasing frequency, while that of the abnormal write head sample 1 remains substantially constant. For example, the inductances of the normal write head sample and the abnormal write head sample are approximately 12.2 nH and 5.3 nH (43% of the inductance of the normal write head sample), respectively, at a frequency of approximately 1 MHz, 10.5 nH and 5.2 nH (50% of the inductance of the normal write head sample) at approximately 600 MHz, and 7.2 nH and 5 nH (69% of the inductance of the normal write head sample) at approximately 600 MHz.

The above evaluation results indicate that if the inductance of the abnormal write head sample 1 is set to be approximately half of that of the normal write head sample 2, the abnormal write head sample 1 exhibits an interline crosstalk amplitude approximately 1.5 times as large as that of the normal write head sample 2. Therefore, when the inductance of the write head is reduced due to occurrence of a circulatory shunt in its coil, etc., the interline crosstalk from the write line 21W to the read line 21R becomes larger, since the time rate of change of the write current increases in the section in which the write current is reversed. It should be noted that the present invention is configured such that the interline crosstalk under normal conditions is set small enough so as not to damage the read head (MR head), and large interline crosstalk occurs only under abnormal conditions.

In view of the above evaluation results, the read-to-write line distance 60 of the transmission line 21 may be set to 3 to 5.5 times (including 5 times) the write line width 61. Furthermore, the interline crosstalk from the write line 21W to the read line 21R may be set such that when the inductance of the load connected to the write line 21W is approximately 43% to 69% (including 50%) of that of a normal load, the magnitude of the interline crosstalk is approximately 1.35 to 2 times (including 1.5 times) as large as that of the interline crosstalk obtained under the normal load.

Description will be made below of an example of the detection unit in the preamplifier for detecting difference between interline crosstalk amplitudes. FIG. 11 shows the configuration of the interline crosstalk amplitude detecting unit in the preamplifier.

As shown in FIG. 11, the interline crosstalk amplitude detecting unit 36 within the preamplifier 20 comprises components such as: an interline crosstalk signal branch circuit 30; an interline crosstalk amplitude detection circuit 31; a comparator 32 for comparing an interline crosstalk amplitude value and a normal reference amplitude value; and a signal source 34 for providing the normal reference amplitude value.

When a write current is output from the write amplifier 20W to the write line 21W, interline crosstalk is induced on the read line 21R according to the conditions of the write line load. As a result, the interline crosstalk signal is input to the read amplifier 20R. The signal is branched by the branch circuit 30 connected to the read amplifier 20R and a branched signal is input to the detection circuit 31 for detecting an interline crosstalk amplitude. To detect a crosstalk amplitude, the detection circuit 31 may be implemented by a sample and hold circuit or a peak hold circuit.

In order to determine whether the magnitude of the amplitude of the interline crosstalk is one obtained under abnormal conditions or normal conditions, the output from the detection circuit 31 is input to one input of the comparator 32, and a threshold value used to determine the magnitude of the amplitude of the interline crosstalk is input to the other input of the comparator 32. This threshold value is set within the range between the amplitude values of interline crosstalks obtained when the write head is in a normal state and in an abnormal state. The threshold value is output from the signal source 34. If the output signal from the detection circuit 31 is larger than the threshold value from the signal source 34, the comparator 32 outputs a write condition abnormality signal (WUS) 35 which is input to a functional component (not shown) for determining occurrence of a write condition abnormality. Then, the functional component determines that a write condition abnormality has occurred.

When the above threshold value is set, the amplitude value of interline crosstalk produced when the write head is in a normal state is used as a reference. The amplitude value of interline crosstalk under normal conditions is obtained as follows.

The output of the interline crosstalk amplitude value detection circuit 31 when the write head is in a normal state is input to one input of the comparator 32, while the output of the signal source 34 is input to the other input as a threshold value. The signal source 34 can vary the threshold value by use of a serial data controller 33. Each threshold value is checked to find the one at which the comparator 32 is inverted. The found threshold value corresponds to the interline crosstalk amplitude value. Therefore, an abnormality can be detected by setting the threshold value to a value larger than the interline crosstalk amplitude value obtained when the write head is in a normal state, since the amplitude of interline crosstalk under abnormal conditions is larger than that for normal conditions.

Thus, the magnetic recording disk drive of the present invention utilizes the fact that the amplitude of the interline crosstalk from the write line 21W to the read line 21R increases when the load inductance of the write line 21W is reduced due to occurrence of a circulatory shunt in the write head coil, etc. The magnetic recording disk drive employs the interline crosstalk amplitude detecting unit 36 within its preamplifier 20 as a means for detecting a coil abnormality (a change in the inductance) in order to ensure magnetic recording function.

Specifically, the interline crosstalk amplitude detecting unit 36 includes the interline crosstalk amplitude detection circuit 31 which is branched from the branch circuit 30 within the read circuit in the preamplifier 20. The interline crosstalk amplitude detecting unit 36 is provided with the capability to determine occurrence of a write condition abnormality when the amplitude has exceeded the threshold value to detect the write condition abnormality. Likewise, the inductance is also reduced when a circulatory shunt has occurred in a line near the head, increasing the interline crosstalk. This makes it possible to detect the write condition abnormality and thereby ensure the recording function of the preamplifier 20.

The present invention utilizes the fact that the amplitude of interline crosstalk increases when the inductance of the write line load is reduced due to occurrence of a circulatory shunt in the write head coil, the write transmission line, etc., which makes it possible to detect a line load abnormality (a circulatory shunt in the write head coil or the write transmission line). Therefore, it is possible to detect a magnetic recording failure in the writing system as well as reducing the occurrence of detection errors.

What is claimed is:

1. A magnetic recording disk drive comprising:
a magnetic head for reading information from a magnetic recording medium and writing information onto the magnetic recording medium;
a first set of conductors communicating signals from said magnetic head during a read operation;
a second set of conductors communicating signals to said magnetic head during a write operation;
said first and second sets being spaced sufficiently closely so that a degree of interline crosstalk occurs when write signals are communicated on said second set of conductors, said degree of interline crosstalk differing between normal and abnormal conditions during write operations; and
a circuit that distinguishes normal and abnormal conditions based on detecting said interline crosstalk and determining whether said degree of interline crosstalk meets a condition specifying an abnormal condition.

2. A magnetic recording disk drive comprising:
a magnetic head for reading/writing information on a magnetic recording medium;
a preamplifier having a write abnormality detection function; and
a transmission line for transmitting read/write signals between said preamplifier and said magnetic head, wherein said transmission line from said preamplifier to said magnetic head includes a section in which a write line and a read line run alongside of each other to produce interline crosstalk, said transmission line being formed such that it is branched within a read preamplifier;
a detection circuit for receiving a signal from a line branched off within said read preamplifier to detect an interline crosstalk amplitude value;
a signal source for outputting a threshold value used to determine whether an interline crosstalk amplitude in said detection circuit is one obtained under normal conditions or abnormal conditions;
a comparator for receiving and comparing an actual interline crosstalk amplitude value and a threshold value, and when said actual interline crosstalk amplitude value is larger than said threshold value, outputting a signal indicating a write condition abnormality, said actual interline crosstalk amplitude value being an output of said detection circuit, said threshold value being an output of said signal source; and
wherein said magnetic recording disk drive has a function to determine occurrence of said write condition abnormality upon receiving said signal indicating said write condition abnormality, said signal being output from said comparator.

3. The magnetic recording disk drive as claimed in claim 2, wherein said transmission line from said preamplifier to said magnetic head is set such that a distance between a center of said write line and a center of said read line in said section in which said write line and said read line run alongside of each other is 3 to 5.5 times a width of said write line.

4. The magnetic recording disk drive as claimed in claim 2, wherein said transmission line from said preamplifier to said magnetic head is configured such that said section in which said write line and said read line run alongside of each other is constructed of one layer or two layers made up of an upper layer and a lower layer, said upper layer being a line, said lower layer being a transmission line made up of a common potential conductor layer.

5. A magnetic recording disk drive comprising:
a magnetic head for reading/writing information on a magnetic recording medium;
a preamplifier having a write abnormality detection function; and
a transmission line for transmitting read/write signals between said preamplifier and said magnetic head;
wherein said magnetic recording disk drive has a function to:
when an inductance of a load connected to a write line is 43% to 69% of an inductance of a normal load, produce an interline crosstalk 1.35 to 2 times as large as an interline crosstalk under said normal load, both interline crosstalks being produced from said write line to a read line in said transmission line from said preamplifier to said magnetic head, an amplitude of said interline crosstalk under said normal load being used as a reference;
detect and recognize a difference between amplitudes of said both interline crosstalks; and
output a signal indicating a write condition abnormality.

6. A method for ensuring magnetic recording function of a magnetic recording disk drive in which a magnetic head reads information from a magnetic recording medium and writes information onto the magnetic recording medium, with read signals being communicated from said magnetic head on a first set of conductors during a read operation and write signals being communicated to said magnetic head on a second set of conductors during a write operation, the method comprising:
during a write operation, sensing signals on the first set of conductors representing interline crosstalk; and
determining whether the signals, so sensed, meet a condition specifying an abnormal write operation.

7. A method for ensuring magnetic recording function of a magnetic recording disk drive, said magnetic recording disk drive comprising:
a magnetic head for reading/writing information on a magnetic recording medium;
a preamplifier having a write abnormality detection function;
a transmission line for transmitting read/write signals between said preamplifier and said magnetic head;
a detection circuit for detecting an actual interline crosstalk amplitude value;
a signal source for outputting a predetermined threshold value;
an external interface for controlling said threshold value output from said signal source; and
a comparator for receiving and comparing an output of said detection circuit and an output of said signal source;
wherein said method comprises:
when an interline crosstalk amplitude under normal conditions is checked, changing said threshold value output from said signal source by use of said external interface, obtaining a threshold value at which an output of said comparator is inverted, and setting said threshold value at which said output of said comparator is inverted as an interline crosstalk amplitude value under normal conditions.

8. The method as claimed in claim 7, wherein said threshold value output from said signal source is set within a range from said interline crosstalk amplitude value under normal conditions to an interline crosstalk amplitude value under abnormal conditions.
